(19) United States
(12) Patent Application Publication
(10) Pub. No.: US 2005/0247862 A1
(43) Pub. Date: Nov. 10, 2005

(54) ACTIVE NIGHT VISION SYSTEM WITH FULLY SYNCHRONIZED LIGHT SOURCE AND RECEIVER

(75) Inventors: Alexander Faytlin, Walled Lake, MI (US); David Hein, Sterling Heights, MI (US); Mark Moore, Canton, MI (US)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/709,438

(22) Filed: May 5, 2004

(51) Int. Cl. H01J 40/14

(52) U.S. Cl. 250/214 VT

(57) ABSTRACT

A method of operating an active night vision system includes generating a first oscillating signal (48). A trigger signal (43) is generated having a duty cycle (51) with a cycle start time (52) and a cycle end time (53). The cycle end time (53) is synchronized with a pulse end time (54) of the first oscillating signal (48). A light source (26) is operated in response to the duty cycle (51).

### BACKGROUND OF INVENTION

The present invention relates to night vision systems, and more particularly, to a system and method of operating a light source and corresponding receiver of an active night vision system.

Night vision systems allow a vehicle occupant to better see objects during relatively low visible light level conditions, such as at nighttime. Night vision systems typically are classified as either passive night vision systems or active night vision systems. Passive systems simply detect ambient infrared light emitted from objects within a particular environment. Active systems utilize a light source to illuminate a target area and subsequently detect infrared light reflected off objects within that area.

Active systems provide improved resolution and image clarity over passive systems. Active systems utilize laser or incandescent light sources to generate an illumination beam having near infrared light energy, and charged coupled devices or CMOS cameras to detect reflected infrared light. Active systems commonly deploy a light source external to the vehicle so as to transmit a significant amount of light energy and provide a bright scene for imaging.

In an active night vision system a near infrared (NIR) diode laser is used to illuminate a target area. A camera is used in conjunction with the laser to receive reflected NIR light from objects within the target area. The laser may be pulsed with a duty cycle of approximately 20-35%. The camera typically contains a band-pass filter that allows passage of light that is within a narrow range or band, which includes the wavelength of the light generated by the laser. The combination of the duty cycle and the use of the band-pass filter aids in eliminating the blinding effects associated with headlamps of oncoming vehicles. The term “blinding effects” refers to when pixel intensities are high due to the brightness of the oncoming lights, which causes an image to be “flooded out” or have large bright spots such that the image is unclear.

It is known that the camera and laser of an active night vision system can be synchronized. The term “synchronized” commonly refers to the aligning of the rising edge of the camera trigger signal, or in other words the time when the laser and the camera are activated, with the falling edge of the camera horizontal oscillating pulse in time to capture an image while the laser is in an “ON” state. However, due to various system parameters that are continuously changing over time and during the operation of the night vision system this synchronization is ineffective in preventing beat frequency affect on a display screen or flickering. The flickering interrupts image viewing and can be perceived by a system operator as annoying or irritating.

Some parameters that can cause this flickering are temperature change, humidity change, and aging of the night vision system. The change in the above stated parameters can cause a camera to not return to the same initial location on a screen during each cycle thereof. The inability to return to the same location causes the stated flickering of the display screen.

Thus, there exists a need for an improved active night vision system and method of generating images that minimizes or eliminates the flickering due to various changing parameters of a night vision system over time and during use thereof.

### SUMMARY OF INVENTION

The present invention provides a system and method of operating an active night vision system. The method includes generating a first oscillating signal. A trigger signal is generated having a duty cycle with a cycle start time and a cycle end time. The cycle end time is synchronized with a pulse end time of the first oscillating signal. A light source is operated in response to the duty cycle.

The embodiments of the present invention provide several advantages. One such advantage is the provision of an active night vision system that synchronizes duty cycle start times and end times of a trigger signal with pulse end times of a reference clock signal. In so doing, the stated embodiment provides improved accuracy in returning a camera or receiver to the same initial display position during the refreshing of the display, which minimizes image flickering and improves image clarity.

Another advantage provided by an embodiment of the present invention is the provision of an active night vision system that provides the above stated advantages and is simple, inexpensive to manufacture and implement, lightweight, and has a compact design.

The present invention itself, together with further objects and attendant advantages, will be best understood by reference to the following detailed description, taken in conjunction with the accompanying drawing.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a front perspective view of an active night vision system incorporating a synchronization circuit in accordance with an embodiment of the present invention;

FIG. 2 is a block diagrammatic view of the synchronization circuit in accordance with an embodiment of the present invention;

FIG. 3 is a signal flow diagram illustrating light source and receiver synchronization in accordance with an embodiment of the present invention;

FIG. 4 is a block diagrammatic view of an illuminator system in accordance with an embodiment of the present invention;

FIG. 5 is a block diagrammatic view of a receiver system in accordance with an embodiment of the present invention;

FIG. 6 is a block diagrammatic view of a resistor/capacitor (RC) synchronization circuit in accordance with another embodiment of the present invention;

FIG. 7 is a block diagrammatic view of a dual counter synchronization circuit in accordance with still another embodiment of the present invention; and

FIG. 8 is a logic flow diagram illustrating a method of operating an active night vision system in accordance with an embodiment of the present invention.

### DETAILED DESCRIPTION

In the following Figures the same reference numerals will be used to refer to the same components. While the present invention is described with respect to a system and method of operating a light source and corresponding receiver of an active night vision system, the present invention may be applied in various applications where near infrared imaging is desired, such as in adaptive cruise control applications, collision avoidance and countermeasure systems, and in image processing systems. The present invention may be applied during daytime hours or at night. The present invention may be applied in various types and styles of vehicles as well as in non-vehicle applications.

Additionally, in the following description the term “near infrared light” refers to light having wavelengths within the infrared light spectrum (750 nm to 1000 nm) and light having wavelengths near or just outside of the infrared light spectrum. The term also includes at least the spectrum of light output by the particular laser diode source disclosed herein.

In the following description, various operating parameters and components are described for one constructed embodiment. These specific parameters and components are included as examples and are not meant to be limiting.

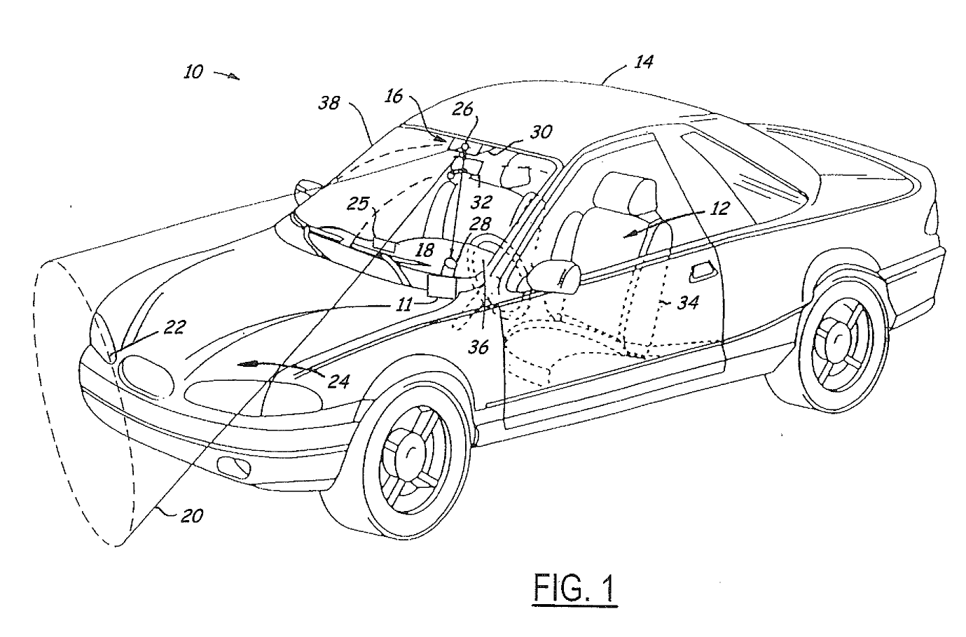

Referring now to FIG. 1, a front perspective view of an active night vision system 10 incorporating a synchronization circuit 11 in accordance with an embodiment of the present invention is shown. The vision system 10 is configured for an interior passenger cabin 12 of a vehicle 14. The vision system 10 includes an illumination system 16 and a receiver system 18. The illumination system 16 generates an illumination beam 20 having a beam pattern 22, which is directed towards a target area 24 that is forward of the vehicle 10. Portions of the illumination beam 20 are reflected off objects (not shown) within the target area 24 and are received by the receiver system 18. The receiver system 18 indicates to vehicle occupants, via an indicator 25, detection of the objects in response to reflected portions of the illumination beam 20. The synchronization circuit 11 synchronizes signal timing of a light source 26 of the illumination system 16 and a receiver 28 of the receiver system 18, which is described in greater detail below.

The illumination system 16 may be configured to be mounted within an overhead console 30 above a rearview mirror 32, and the receiver system 16 may be configured to be mounted forward of a driver seat 34 on a dashboard 36. Of course, the illumination system 16 and receiver system 18 may be mounted in other locations around windshield 38, as well as in other window and non-window locations within the vehicle 14.

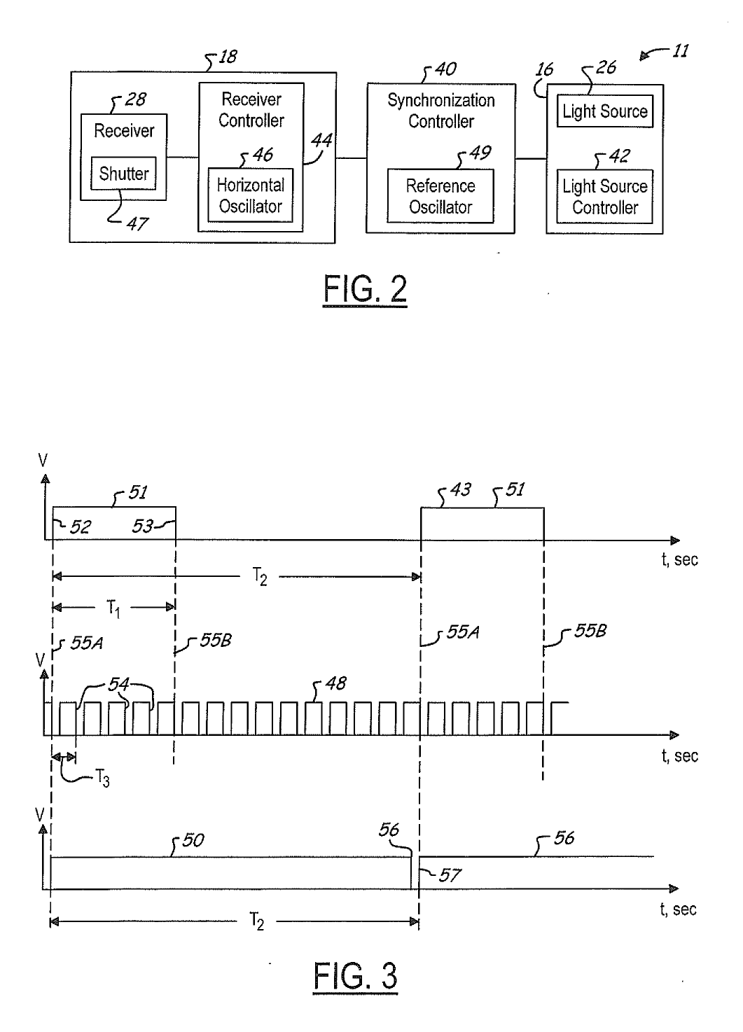

Referring now to FIGS. 2 and 3, a block diagrammatic view of the synchronization circuit 11 and a signal flow diagram illustrating light source and receiver synchronization are shown in accordance with an embodiment of the present invention. The synchronization circuit includes the illumination system 16, the receiver system 18, and a synchronization controller 40.

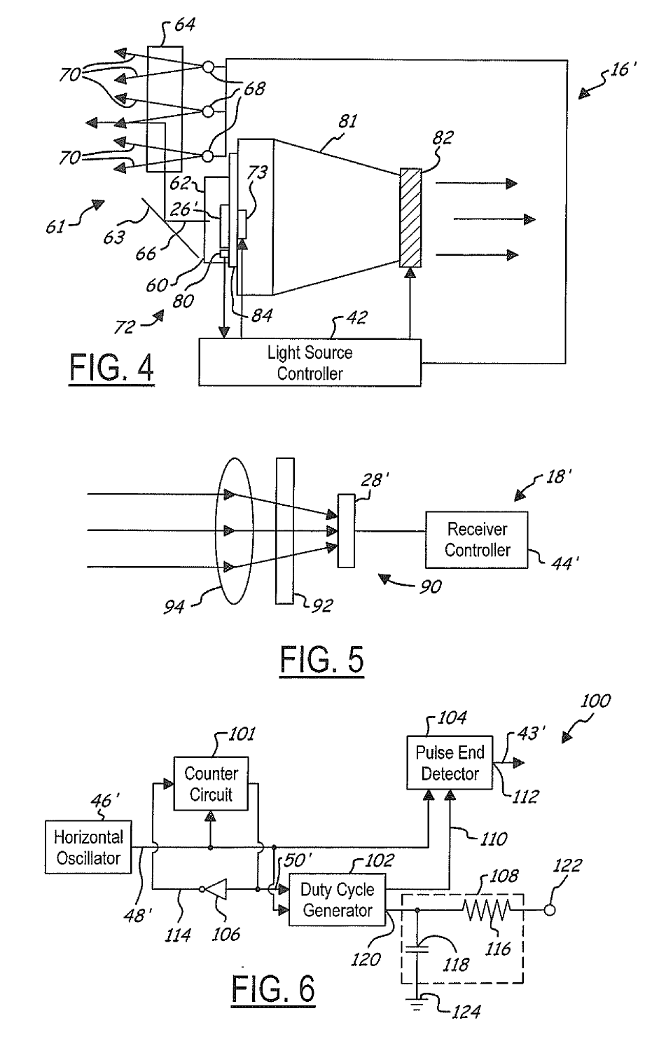

The illumination system 16 includes the light source 26 and a light source controller 42. The light source 26 may be of various types and styles. In one embodiment of the present invention the light source 26 is a near infrared diode laser, having desired monochromatic and illumination characteristics. The diode laser may, for example, be a Single Stripe Diode Laser, Model No. S-81-3000-C-200-H manufactured by Coherent, Inc. of Santa Clara, Calif. The light source controller 42 operates the light source 26 in response to a synchronized trigger signal 43 from the synchronization controller 40 and may perform other light source related tasks known in the art, some of which are stated below. A sample illumination system is described in greater detail with respect to FIG. 4.

The receiver system 18 includes the receiver 28 and a receiver controller 44 having a horizontal oscillator 46. The receiver 28 may be in the form of a charge-coupled device (CCD) camera or a complementary metal oxide semiconductor (CMOS) camera. A CCD camera, Model No. Wat902HS manufactured from Watec America Corporation of Las Vegas, Nevada may, for example, be used as the receiver 28. The receiver controller 44 controls operation of the receiver, such as the timing of a shutter 47. The horizontal oscillator 46 generates a first oscillation signal 48 that is used in the refreshing of an image. The frequency of the first oscillation signal corresponds with a horizontal line refresh rate of the receiver system 18. In one embodiment of the present invention, the first oscillating signal has a first oscillating frequency of approximately 15.75 kHz. The horizontal oscillator 46 provides a precise and reliable oscillating signal. A sample receiver system is described in greater detail with respect to FIG. 5.

The synchronization controller 40 includes a reference oscillator 49 that generates a second oscillation signal 50. In an example embodiment, the second oscillating signal has a second oscillating frequency of approximately 60 Hz. The synchronization controller generates the trigger signal to activate and deactivate the light source and the receiver in response to the first oscillating signal and the second oscillating signal.

The synchronization controller 40 assures that the trigger signal 43 is “fully” synchronized with the first oscillating signal 48. The trigger signal has duty cycles 51 of approximately 20-35%. Although a duty cycle of approximately 20%-35% is shown, other duty cycles between 0-100% may be used. The duty cycles 51 represent when the light source 26 and the receiver 28 are activated. The light source 26 and the receiver 28 are deactivated between duty cycles. The duty cycles 51 have cycle start times corresponding with rising edges 52 and cycle end times corresponding with falling edges 53. The time between the rising edges and the falling edges is represented by T₁. The time between sequential rising edges 52 is represented by T₂. Time T₂ is the refresh time set by the second oscillating signal 50, described further below. The synchronization controller assures that the edges 52 and 53 align with the pulse falling edges 54 of the first oscillating signal 48, which is defined as fully synchronized and is designated by dashed lines 55A and 55B. The pulse falling edges 54 signify the end of a pulse within the first oscillating signal 48. Time between sequential pulse falling edges 54 is represented by T₃.

Although the edges 52-54 are utilized, other edges may be utilized and signify the cycle start times and end times of the duty cycles 51 and pulse end times of the first oscillating signal 48. Also, the synchronization controller 40 may operate in dual modes, a fixed duty cycle mode or an adjustable duty cycle mode. The fixed duty cycle mode refers to operating with a single set duty cycle. The adjustable duty cycle mode refers to the ability to adjust or vary the length or percentage of each duty cycle.

Reference pulses 56 within the second oscillating signal 50 signify a refresh cycle of the receiver 28. As an example, the time duration T between the beginning and end of a single reference pulse 56 may be approximately equal to the amount of time to refresh 263 lines of a field within an image; the image having two interlaced fields. Each reference pulse 56 within the second oscillating signal 50 may correspond with 263 pulses in the first oscillating signal 48. The rising edges 57 of the reference pulses 56 signify a reset or a refresh cycle initiation.

The synchronization controller 40, the light source controller 42, and the receiver controller 44 may be microprocessor based such as a computer having a central processing unit, memory (RAM and/or ROM), and associated input and output buses. The controllers 40, 42, and 44 may be application-specific integrated circuits or may be formed of other logic devices known in the art. The controllers 40, 42, and 44 may be a portion of a central vehicle main control unit, an interactive vehicle dynamics module, a restraints control module, a main safety controller, may be combined into a single integrated controller, or may be stand-alone controllers as shown.

The indicator 25 may include a video system, an audio system, an LED, a light, global positioning system, a heads-up display, a headlight, a taillight, a display system, a telematic system or other indicator known in the art. The indicator 25 may indicate position, range, and traveling speed relative to the vehicle, as well as other known object parameters or characteristics. Objects may include any animate or inanimate objects including pedestrians, vehicles, road signs, lane markers, and other objects known in the art. In one embodiment of the present invention, the indicator 25 is in the form of a heads-up display and the indication signal is projected to appear being forward of the vehicle 14. The indicator 25 provides a real-time image of the target area to increase the visibility of objects during relatively low visible light level conditions without having to refocus ones eyes to monitor a display screen within the interior cabin.

Referring now to FIG. 4, a block diagrammatic view of a sample illuminator system 16′ in accordance with an embodiment of the present invention is shown. The illumination system 16′ includes a light source assembly 60 that generates light, which may be emitted from the assembly 60 in the form of an illumination beam, such as beam 20. Light generated from the light assembly 60 is directed through an optic assembly 61 where it is collimated to generate the illumination pattern 22. The illumination beam 20 is emitted from the light assembly 60 and passed through the windshield 38. The light assembly 60 includes a light source 26′ that is contained within a light source housing 62.

The optical system 61 includes the light assembly 60, a light coupler 63, and a beam-forming optic 64. Light from the light source 26′, represented by arrow 66, is emitted towards and is reflected by the light coupler 63 to the optic 64, where it is again reflected towards and through the windshield 38. The light coupler 63 and the optic 64 may be contained within a component alignment maintaining module or housing (not shown). The optical system 61 may also include a series of light emitting diodes (LEDs) 68 or the like for performing color mitigation and for adjusting perceived color of the illumination beam 20. Light emitted by the LEDs 68 is represented by arrows 70.

The illumination system 16′ may also include a thermal control system 72 with a heater 73. The heater 73 may be utilized in conjunction with the thermal sensor 80 in controlling the temperature of the light source 26′. The thermal control system 72 may also include a cooling assembly 81 that has a cooling device 82. The cooling device 82 may be in the form of a cooling fan or some other form known in the art. The cooling device 82 is in operative response to the thermal sensor 80, via the light source controller 42. A heat sink 84 is provided and allows thermal energy transfer between the light assembly 60 and the cooling assembly 81. The thermal system 72 circulates air around the heat sink 84 and disperses thermal energy from the heat sink 84.

Referring now to FIG. 5, a block diagrammatic view of a sample receiver system 18′ in accordance with an embodiment of the present invention is shown. The receiver system 18′ includes a receiver assembly 90 having a receiver 28′, a filter 92, and a lens 94. Near infrared light reflected off objects is received by the receiver 28′ to generate an image signal. The filter 92 is used to filter the reflected near infrared light. The filter 92 may be separate from the lens 94 and the receiver 28′, as shown, or may be in the form of a coating on the lens 94 or a lens of the receiver 28′. The filter may be a digital or analog filter located within the receiver 28′.

Referring now to FIG. 6, a block diagrammatic view of a resistor/capacitor (RC) synchronization circuit 100 in accordance with another embodiment of the present invention is shown. The synchronization circuit 100 includes a horizontal oscillator 46′, similar to the horizontal oscillator 46. The horizontal oscillator 46′ is coupled to a counter circuit 101, a duty cycle generator 102, and a pulse end detector 104. The synchronization circuit may also include an inverter 106 and a RC circuit 108. The counter circuit 101 may include a binary counter, such as the Motorola™ Corporation Model #MC14040B, a NAND gate, and other circuitry known in the art that may be utilized to generate an oscillating signal. The duty cycle generator 102 may be in the form of a dual precision retriggerable/resettable monostable multivibrator, such as the Motorola™ Corporation Model #MC14538B, or may be in some other form known in the art. The duty cycle generator 102 may be in the form of a micro controller that is capable of generating a duty cycle. The pulse end detector 104 may be in the form of a Flip-Flop, such as the Motorola™ Corporation Model #MC14013B, or may be in some other form known in the art.

In operation, the counter circuit 101, the duty cycle generator 102, and the pulse end detector 104 receive a first oscillating signal 48′, which is similar to the first oscillating signal 48 from the horizontal oscillator 46′. The counter circuit generates a second oscillating signal 50′, similar to the second oscillating signal 50, in response to the first oscillating signal 48′.

The duty cycle generator 102 generates a pre-trigger signal 110 having a first duty cycle in response to the first oscillating signal 48′ and the second oscillating signal 50′.

The first duty cycle is similar to the duty cycle 51, except that the cycle end time or falling edge thereof is not necessarily synchronized with a pulse end time or pulse falling edge of the first oscillating signal 48′. The pretrigger signal 106 is therefore “partially” synchronized.

The pulse end detector 104 generates a post-trigger signal 43′ that is similar to the trigger signal 43. The pulse end detector 104 causes the output 112 thereof to be “Low” when it detects a falling edge on both the first oscillating signal 48′ and the pre-trigger signal 110. In so doing, the pulse end detector assures that the cycle end time or falling edge of the pre-trigger signal 110 is synchronized with a pulse end time or falling edge of the first oscillating signal 48′. The post-trigger signal 43′ is fully synchronized.

The synchronization circuit 100 includes a feedback loop 114, which is used as a reset to synchronize the cycle start times of the pre-trigger signal 110 and the posttrigger signal with the pulse start time of the second oscillating signal 50′. This reset signifies the beginning of a subsequent refresh cycle.

The RC circuit 108 includes a resistor 116 and a capacitor 118. The resistor 116 is coupled between an input 120 of the duty cycle generator 102 and a reference connection 122. The capacitor 118 is coupled between the input 120 and the ground 124. The reference connection 122 provides duty cycle adjustment value, which is used by the duty cycle generator 102 in response to the time constant of the RC circuit 108 to adjust length or percentage of the duty cycle of the pre-trigger signal 110, and thus the post-trigger signal 43′.

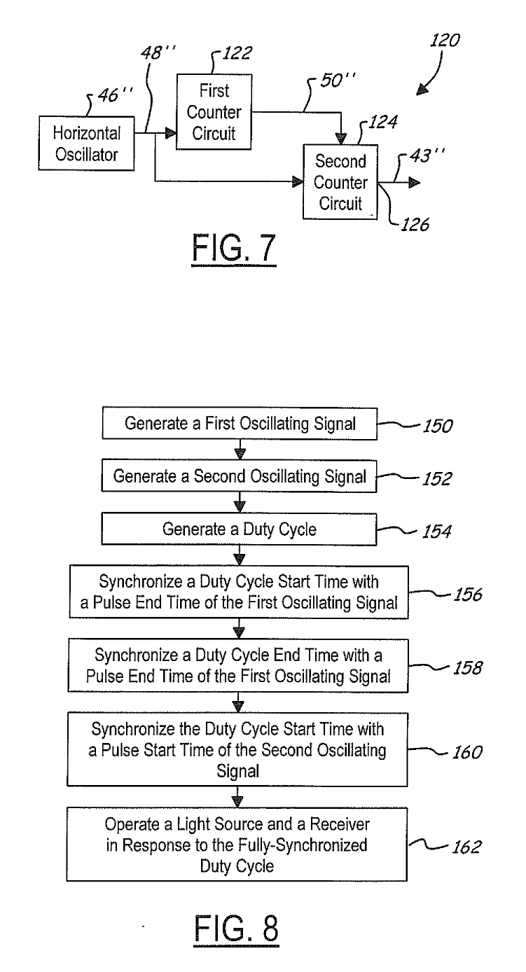

Referring now to FIG. 7, a block diagrammatic view of a dual counter synchronization 120 circuit in accordance with still another embodiment of the present invention is shown. The dual counter circuit 120 includes a horizontal oscillator 46″ that is similar to the horizontal oscillators 46 and 46′. A first counter circuit 122 and a second counter circuit 124 are coupled to the horizontal oscillator 46″.

The first counter circuit 122 is similar to the counter circuit 101 in that it generates a second oscillating signal 50″ in response to the first oscillating signal 48″. The second counter circuit generates a trigger signal 43″ in response to the first oscillating signal 48″ and the second oscillating signal 50″. The second counter circuit 124, in effect, counts a determined number of pulses within the first oscillating signal 48″ that have a summed duration, which is equivalent to the duration of a duty cycle or 20-35% of a pulse period of the second oscillating signal 50″. The output 126 of the second counter circuit 124 is “High” or represents an active state for the duration of the determined number of pulses and is Low otherwise. This also assures that the cycle start times and cycle end times of the trigger signal 43″ are synchronized with the pulse end times of the first oscillating signal 48″.

Referring now to FIG. 8, a logic flow diagram illustrating a method of operating an active night vision system is shown.

In step 150, a first oscillating signal is generated, such as oscillating signals 48, 48′, and 48″. The first oscillating signal may be generated by a horizontal oscillator, such as the oscillators 46, 46′, and 46″, or by some other oscillator known in the art.

In step 152, a second oscillating signal, such as the second oscillating signals 50, 50′, and 50″, is generated. The second oscillating signal may be generated by a reference oscillator or a counter circuit, as stated above, or by some other device known in the art.

In step 154, a duty cycle having a duty cycle start time and a duty cycle end time is generated, such as the duty cycle 51.

In step 156, the cycle start time is synchronized with a pulse end time of the second oscillating signal to generate a partially synchronized duty cycle. This may be performed by a controller, a duty cycle generator, or a counter circuit, as stated above, or by some other similar device known in the art.

In step 158, the cycle end time is synchronized with a pulse end time of the second oscillating signal to generate a fully synchronized duty cycle. This may be performed by a controller, a pulse end detector, or a counter circuit, as stated above, or by some other device known in the art.

In step 160, the cycle start time is also synchronized with a pulse start time of the second oscillating signal. This may also be performed by a controller, by a reset feedback loop, by a counter circuit, or by some other mechanism known in the art.

In step 162, a light source and a receiver are operated in response to the fully synchronized duty cycle.

The above-described steps are meant to be illustrative examples; the steps may be performed sequentially, synchronously, simultaneously, or in a different order depending upon the application.

The present invention provides an active night vision system with a light source and a receiver that are operated in response to a fully synchronized duty cycle. As such, the present invention aids in the accurate return to an initial screen starting point, which minimizes and/or eliminates flickering of a screen or display image.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A method of operating an active night vision system comprising:
generating a first oscillating signal;
generating a trigger signal having a duty cycle with a cycle start time and a cycle end time;
synchronizing said cycle end time with a pulse end time of said first oscillating signal; and
operating a light source in response to said duty cycle.

2. A method as in claim 1 further comprising operating a receiver in response to said duty cycle.

3. A method as in claim 2 wherein said light source and said receiver are activated at said cycle start time and deactivated at said cycle end time.

4. A method as in claim 1 wherein generating a trigger signal having a duty cycle with a cycle start time and a cycle end time is performed via a controller.

5. A method as in claim 1 wherein synchronizing said cycle end time with a pulse end time of said first oscillating signal is performed via a controller.

6. A method as in claim 1 further comprising:
generating a second oscillating signal in response to said first oscillating signal; and
synchronizing said cycle start time with a pulse start time of said second oscillating signal.

7. A method as in claim 1 further comprising synchronizing said cycle start time with a pulse end time of said first oscillating signal.

8. A method as in claim 7 wherein synchronizing said cycle start time with a pulse end time comprises synchronizing a rising edge of said duty cycle with a falling edge of said first oscillating signal.

9. A method as in claim 1 wherein synchronizing said cycle end time with a pulse end time comprises synchronizing a first falling edge of said duty cycle with a second falling edge of said first oscillating signal.

10. An active night vision system comprising:
a counter circuit receiving a first oscillating signal and generating a second oscillating signal;
a duty cycle generator generating a pre-trigger signal having a first duty cycle in response to said first oscillating signal and said second oscillating signal;
a pulse end detector detecting pulse endings of said first oscillating signal and said second oscillating signal and generating a post-trigger signal having a second duty cycle; and
a light source controller operating a light source in response to said second duty cycle.

11. A system as in claim 10 further comprising a receiver operating in response to said second duty cycle.

12. A system as in claim 10 further comprising a receiver having an oscillator generating said first oscillating signal.

13. A system as in claim 12 wherein said oscillator is a horizontal oscillator.

14. A system as in claim 10 wherein said pre-trigger signal is partially synchronized with said first oscillating signal.

15. A system as in claim 10 wherein said post-trigger signal is fully synchronized with said first oscillating signal.

16. A system as in claim 10 wherein said second oscillating signal is in the form of an approximately 60 Hz oscillating signal.

17. A system as in claim 10 wherein said duty cycle generator is in the form of a resistor/capacitor (RC) circuit.

18. A system as in claim 10 wherein said pulse end detector is in the form of a flip-flop circuit.

19. An active night vision system comprising:
a first counter circuit receiving a first oscillating signal and generating a second oscillating signal;
a second counter circuit generating a trigger signal having a duty cycle with a cycle start time and a cycle end time in response to said first oscillating signal and said second oscillating signal;
said second counter circuit synchronizing said cycle end time with a second pulse end time of said first oscillating signal; and
a light source controller operating a light source in response to said duty cycle.

20. A system as in claim 19 wherein said second counter circuit synchronizes said cycle start time with a first pulse end time of said first oscillating signal.
